(19) United States
(12) Patent Application Publication
(10) Pub. No.: US 2019/0026671 A1
(43) Pub. Date: Jan. 24, 2019

(54) Device, System, and Method for Optimizing Taxi Dispatch Requests

(71) Applicant: DTA International FZCO, Fargo, ND (US)

(72) Inventors: Rashid AL FALASI, Amman (JO); Raj BRIDGELALL, Fargo, ND (US)

(21) Appl. No.: 15/655,556

(22) Filed: Jul. 20, 2017

(51) Int. Cl. G06Q 10/06; G08G 1/00; G01C 21/34

(52) U.S. Cl. CPC G06Q 10/06315; G01C 21/3438; G08G 1/202

(57) ABSTRACT

A device, system, and method optimizes taxi dispatch requests. The system comprises delivery vehicles located within a dispatch region and a dispatch center processing dispatch requests and receiving data including status information with corresponding timestamps of availability of the delivery vehicles. The method includes receiving a new dispatch request. The method includes determining a dynamic pooling scheme is to be used, the dynamic pooling scheme waiting for the pool of the available delivery vehicles to grow to reach a predetermined pooling size prior to selecting a delivery vehicle for the new dispatch request. The method includes determining a respective overall cost associated with pairing each available delivery vehicle to the new dispatch request. The method includes selecting a pairing based on the respective overall costs. The method includes dispatching a selected available delivery vehicle in the optimal pairing to service the new dispatch request.

### BACKGROUND INFORMATION

A taxi may provide a delivery service of picking up one or more passengers from a first location and dropping off the passengers to a second location. The taxi may be located in a region or a zone in the region to provide this delivery service. The taxi may also be part of a fleet of taxis throughout the region. The delivery service provided by the taxis may include unscheduled requests (e.g., a street hailed request) or scheduled requests (e.g., a dispatch request received from a passenger to a centralized dispatch center). Although the street hailed requests are unpredictable in nature and a pairing of a taxi to the street hailed request is not capable of being determined, the dispatch requests may match a taxi to the dispatch request such that an associated cost in providing the delivery service for the dispatch requests is minimized. For example, the cost may include a time that the requesting passenger waits for the taxi to arrive and also a time that the taxi remains empty or unused while not providing the delivery service. The approach used in matching the taxi to the dispatch request are often on a first come first serve basis via a queuing scheme in which a queue of the requests is serviced from earliest to latest and a queue of available taxis is used to select a taxi at the top of the queue (while also obeying zonal constraints). However, such an approach does not optimize the manner in which the dispatch requests are serviced. That is, the cost of the passenger waiting and the cost of an empty taxi are not minimized by using this approach.

### SUMMARY

The exemplary embodiments are directed to a method, comprising: in a system comprising a plurality of delivery vehicles to perform deliveries located within a dispatch region and a dispatch center processing dispatch requests for delivery from a pickup location to a drop-off location, the delivery vehicles configured to transmit data to the dispatch center, the data including status information with corresponding timestamps indicative of an availability of the delivery vehicles: receiving a new dispatch request, the new dispatch request including a new pickup location and a new drop-off location; determining whether one of the delivery vehicles is to be selected based on a dynamic pooling scheme, the dynamic pooling scheme waiting for the pool of the at least one available delivery vehicles to grow to reach a predetermined pooling size prior to selecting one of the delivery vehicles to pair with the new dispatch request; determining a respective overall cost associated with each pairing of the at least one available delivery vehicle to the new dispatch request; selecting a pairing based on the respective overall costs; and dispatching the selected available delivery vehicle in the optimal pairing to service the new dispatch request.

The exemplary embodiments are directed to a dispatch server processing dispatch requests for delivery from a pickup location to a drop-off location in a dispatch region, the dispatch region including a plurality of delivery vehicles to perform deliveries, the dispatch server comprising: a transceiver configured to exchange data with the delivery vehicles, the data including status information with corresponding timestamps indicative of an availability of the delivery vehicles, the transceiver receiving a new dispatch request, the new dispatch request including a new pickup location and a new drop-off location; and a processor determining whether one of the delivery vehicles is to be selected based on a dynamic pooling scheme, the dynamic pooling scheme waiting for the pool of the at least one available delivery vehicles to grow to reach a predetermined pooling size prior to selecting one of the delivery vehicles to pair with the new dispatch request, the processor determining a respective overall cost associated with each pairing of the at least one available delivery vehicle to the new dispatch request, the processor selecting a pairing based on the respective overall costs, wherein the transceiver transmits an offer to the selected available delivery vehicle in the optimal pairing to service the new dispatch request.

The exemplary embodiments are directed to a system, comprising: a plurality of delivery vehicles located in a dispatch region, the delivery vehicles perform deliveries in the dispatch region, the delivery vehicles comprising components configured to generate and transmit data, the data including status information with corresponding timestamps indicative of an availability of the delivery vehicles and location information with corresponding further timestamps indicative of a respective position of the delivery vehicles within the dispatch region; and a dispatch center configured to exchange the data and further data with the delivery vehicles, the dispatch center receiving a new dispatch request including a new pickup location and a new drop-off location, the dispatch center determining whether one of the delivery vehicles is to be selected based on a dynamic pooling scheme, the dynamic pooling scheme waiting for the pool of the at least one available delivery vehicles to grow to reach a predetermined pooling size prior to selecting one of the delivery vehicles to pair with the new dispatch request, the dispatch center determining a respective overall cost associated with each pairing of the at least one available delivery vehicle to the new dispatch request, the dispatch center selecting a pairing based on the respective overall costs, the dispatch center transmitting an offer to the selected available delivery vehicle in the optimal pairing to service the new dispatch request.

### BRIEF DESCRIPTION OF THE DRAWINGS

FIG. 1 shows an exemplary system of a plurality of taxis selectable for a request according to various exemplary embodiments described herein.

FIG. 2 shows a dispatch server of the system of FIG. 1 according to various exemplary embodiments described herein.

FIG. 3 shows a method for determining how a taxi selected to service a request according to various exemplary embodiments described herein.

### DETAILED DESCRIPTION

The exemplary embodiments may be further understood with reference to the following description and the related appended drawings, wherein like elements are provided with the same reference numerals. The exemplary embodiments are related to a device, system, and method for optimizing how a taxi dispatch request is serviced by selecting a pairing of a taxi to the dispatch request that minimizes an overall cost to the system for dispatching taxis. Specifically, the exemplary embodiments provide a dispatch scheme that utilizes a dynamic pooling scheme in which an individual empty vehicle time may be increased but results in a first average cost of passenger wait time of a plurality of passengers who submitted a dispatch request to be minimized and a second average cost of empty vehicle time of a plurality of taxis available to service the dispatch requests to also be minimized. As will be described in further detail below, the dispatch scheme according to the exemplary embodiments may also include a queuing scheme such that the mechanism according to the exemplary embodiments initially determines whether the dynamic pooling scheme or the queuing scheme is to be used and subsequently determine how the dynamic pooling scheme is to be used when warranted.

Initially, it is noted that the exemplary embodiments are described with regard to taxis and providing a delivery service for passengers in a geographic region. However, the use of the taxis is only exemplary. The exemplary embodiments may also be used or may be modified to be used with other vehicles and services. For example, the vehicles may include road vehicles, rail vehicles, water taxis, ships, aircrafts, etc. In another example, the services may include moving people and/or objects. It is also noted that the vehicles are understood to be driven by a human driver. However, the exemplary embodiments may also be utilized in a system where the vehicles are autonomously driven or a system including a combination of manually driven and autonomously driven vehicles. Accordingly, when the exemplary embodiments are described with taxis and a delivery service for passengers, it is to be understood that the taxi represents any delivery vehicle and the delivery service for passengers represents any delivery service.

The exemplary embodiments are directed to taxi dispatch optimization. Specifically, the exemplary embodiments are described with regard to taxi dispatch requests and dispatching taxis to service these requests. Accordingly, the exemplary embodiments pertain to scheduled taxi requests in which a passenger contacts a dispatch center to have a taxi arrive at a location for pick up to provide the delivery service rather than street hailed requests in which a passenger directly hails a taxi to provide the delivery service. Regardless of the types of requests that are serviced by a given taxi, the taxi may generate data that is used to create a taxi trip record that contains times and positions of pickup and drop-off events. This data may be used to determine a status of the taxi such as whether the taxi is currently servicing a request (dispatch request or street hailed request) or is empty and available to service a new request.

With each of a plurality of taxis servicing either a dispatch request or a street hailed request or not servicing any request during a given period of time, the availability of taxis and the scheduling of dispatch requests is random. The physical location of each taxi in a region is also random. However, the stochastics of temporal and spatial variations in the pickup and drop-off events for each of the requests characterize the nature of the demand and the supply, respectively, for the region. In optimizing how dispatch requests are serviced, key performance indicators may be statistics related to pickup wait times and total empty taxi times. Accordingly, by minimizing these two factors, the manner in which dispatch requests are serviced may be optimized for the system including taxis and passengers. Therefore, with mean and standard deviations of both factors quantifying the relative performances of a given dispatching scheme, an overall efficiency increases when the empty taxi times decrease, the level of service increases when the pickup wait time decreases, and the service reliability improves when the spread of the key performance indicators decrease.

A conventional approach in deploying a taxi to service a dispatch request is by enforcing a pickup from one or more zones within a region. Accordingly, a particular taxi may only perform a pickup from an associated zone but perform the drop-off in any zone (as the drop-off location is at the request of the passenger). In servicing the dispatch requests, a dispatch center may receive a dispatch request from a passenger and enter the dispatch request into a corresponding dispatch queue that is associated with each zone in the region. Taxis associated with a given zone may report availability to service a dispatch request to the dispatch center to place the taxi into an availability queue for that zone. With these two individual queues, the conventional approach uses a queuing scheme in which the first taxi in the availability queue is offered the first dispatch request in the dispatch queue.

The dispatch center may use a modified queuing scheme in which each queue is serviced by dispatching the earliest or the closest available taxi in the availability queue for the zone to the position of the earliest dispatch request in the dispatch queue. It is noted that the instant of arrival of an available taxi or the pickup request time (whichever is later) is an earliest possible dispatch time for any zone. A dispatch window defines an absolute time difference between the availability of a taxi and the pickup request time. An additional wait time to fulfill the pickup request relates to a time difference between dispatching the taxi to arrive at the position indicated in the dispatch request and a meter engagement time when the passenger has been picked up. Therefore, the total empty taxi time is defined by a sum of the dispatch wait time while the taxi remains in the availability queue without servicing any request (e.g., a street hailed request) and the empty travel time (after the dispatch request is accepted and the passenger has been picked up) until the meter engages. As those skilled in the art will understand, after the dispatch request has been serviced, the zone constraints dictate that the taxi must return to its designated zone (referred to as a “mark”). Therefore, the zone constraints may cap a typical taxi utilization efficiency to less than 50% as the taxi must return empty to the mark (assuming the dispatch request had a drop off location outside the designated zone). However, without zones, the taxi utilization efficiency may potentially approach 100% (e.g., in high demand situations when the wait times for passengers approach zero).

The modified queuing scheme operates by servicing dispatch requests in the order that they arrive. However, those skilled in the art will understand that the modified queuing scheme includes exceptions to this temporal (or spatial) ordering. In a first example, the modified queuing scheme may make an exception when there are no taxis that are available in the zone at the time of the pickup request (e.g., no taxis in the availability queue). The dispatch center may accordingly wait for a taxi assigned to that zone to become available. However, if there is still no available taxi, the dispatch center may seek an available taxi in an adjacent zone (physically adjacent or within a predetermined travel time to the current zone). If no taxis are available in adjacent zones, after a time period (e.g., 1 hour after receiving the dispatch request), the dispatch center may cancel the dispatch request. In a second example, the modified queuing scheme may make an exception when a taxi is offered the dispatch request but is rejected. In such a situation, the dispatch center moves onto the next available taxi in the availability queue for the zone and continues this process until a taxi accepts the dispatch request. It is noted that the taxis that reject the dispatch request may remain in their position in the availability queue or may be moved to the end of the availability queue. In a third example, the modified queuing scheme may make an exception when more than one taxi is available at the time of the pickup request (and in a common place on the availability queue). In such a situation, the dispatch center may offer the dispatch request first to the taxi that is closest to the pickup location indicated by the dispatch request.

In view of the various considerations of the modified queuing scheme, it is evident that the potential optimization in servicing dispatch requests by taxis is limited to account for these considerations. Specifically, the zonal constraints increase the empty taxi time as well as limit the availability of taxis to service requests. For example, a first zone may have no taxis in the availability queue but a second zone may have a plurality of taxis in the availability queue. However, the taxis associated with the second zone may not be used for the first zone. Thus, the exemplary embodiments are configured to improve the manner in which taxis service dispatch requests while retaining the characteristics associated with taxis (e.g., servicing both dispatch requests and street hailed requests). One manner of improving the optimization of the modified queuing scheme is by incorporating features of other dispatch schemes that have shown to include improvements to particular factors.

Developments in passenger delivery services have expanded beyond taxis. For example, Transportation Network Companies (TNCs) such as Uber, Lyft, Careem, etc. have been proliferating in nearly all major cities to provide shared mobility services. Essentially, the TNCs use a dispatch request process in which a passenger enters a request to the TNC and a match with a driver of a delivery vehicle is found to service the request. Accordingly, the TNCs do not incorporate unscheduled requests or street hailed requests (e.g., only local taxis may be granted such a privilege).

The TNCs provide a shared mobility service at any time and in any location. The operational efficiencies of the TNCs hinge on a real-time ride-sourcing system. The TNCs use dynamic matching algorithms as subsystems to automatically pair passengers and drivers. As those skilled in the art will understand, research comparing ride-sourcing systems such as the TNCs and traditional taxis (servicing dispatch requests and street hailed requests) has indicated that the wait times for ride-sourcing systems are dramatically shorter and more consistent than those of taxis. When comparing the shared mobility service of the ride-sourcing systems in the TNCs and servicing dispatch requests by taxis, one critical difference is that the shared mobility service does not operate within zonal constraints that the taxis do. Therefore, the dynamic matching algorithms of the TNCs pair passengers with drivers that are within close proximity, both in space and time, forgoing any use of a queue. Without zonal constraints, the TNCs have the freedom to market value-added services such as shared rides, shared tours, and inter-zonal shuttling services. Thus, the freedom from zonal constraints poses a fundamental competitive advantage over zone-based dispatching services. It is noted that there is no evidence that the TNCs use any form of dynamic pooling and pool-size decision-making to pair passengers with drivers, the pooling being features of the exemplary embodiments to be described in detail below. Nevertheless, those skilled in the art will appreciate that the algorithms used by the TNCs may not be ported directly for use with traditional taxis that also provide services for impromptu or street hailed requests. By introducing the street hailed requests, the availability and location of the taxis become affected that prevent simply utilizing the algorithms of TNCs.

In view of the potential improvements to optimization in servicing dispatch requests by taxis and the evidence of lowering costs with features of the algorithms of the TNCs, the exemplary embodiments provide an alternative scheme to improve the dispatching effectiveness by using a dynamic pooling feature. When certain supply conditions hold (e.g., the number of available taxis), the dynamic pooling scheme of servicing dispatch requests waits beyond a minimum dispatch window time to allow a pool of available taxis to grow to a predetermined pooling size. A cost minimization algorithm associated with the dynamic pooling scheme may be used to select a taxi from the pool that substantially reduces the mean and spread in an overall empty taxi time for all the taxis in the system as well as reduce the mean and spread of pickup wait times of the passengers. That is, when certain conditions allow for use of the dynamic pooling scheme, the dynamic pooling scheme is configured to wait for the pool of available taxis to reach some optimum pooling size (which may incidentally increase an empty taxi time on an individual level) but yields a maximum likelihood that the reduction in the overall empty taxi time is much greater than the individual wait time.

As noted above, the dynamic pooling scheme may realize the improvements to optimization of servicing dispatch requests by taxis when certain conditions are present in the system. However, when these conditions are not present, using the dynamic pooling scheme may have an opposite effect. Accordingly, the exemplary embodiments are also configured to retain using the modified queuing scheme which has a standard efficiency when the conditions are not present. As will be described in further detail below, the conditions may relate to when the pool of available taxis is at least one or some value in which a reduction in cost is unlikely. Accordingly, the exemplary embodiments dynamically select between the dynamic pooling scheme when the conditions allow and otherwise defer to the modified queuing scheme.

To illustrate how the exemplary embodiments provide an overall improvement to the deploying of taxis in servicing dispatch requests, the conditions associated with using the dynamic pooling scheme are developed to guide a dynamic adaptation of determining a pooling size to use under the proper circumstances. As will become apparent below, the conditions are a function of the supply and demand dynamics over space and time. Therefore, the exemplary embodiments dynamically determine both when and by how much the pooling size should grow under a current set of circumstances to substantially increase the probability that a taxi becomes available within a proximity of the pickup location of a dispatch request to be serviced as well as decrease the overall mean and spread of empty travel times for all of the remaining taxis in the pool of taxis. With a dependency on the supply and demand situation, the description herein also illustrates an analysis and understanding of both the spatial and temporal nature of supply and demand in the intended region of deployment of the dynamic pooling scheme.

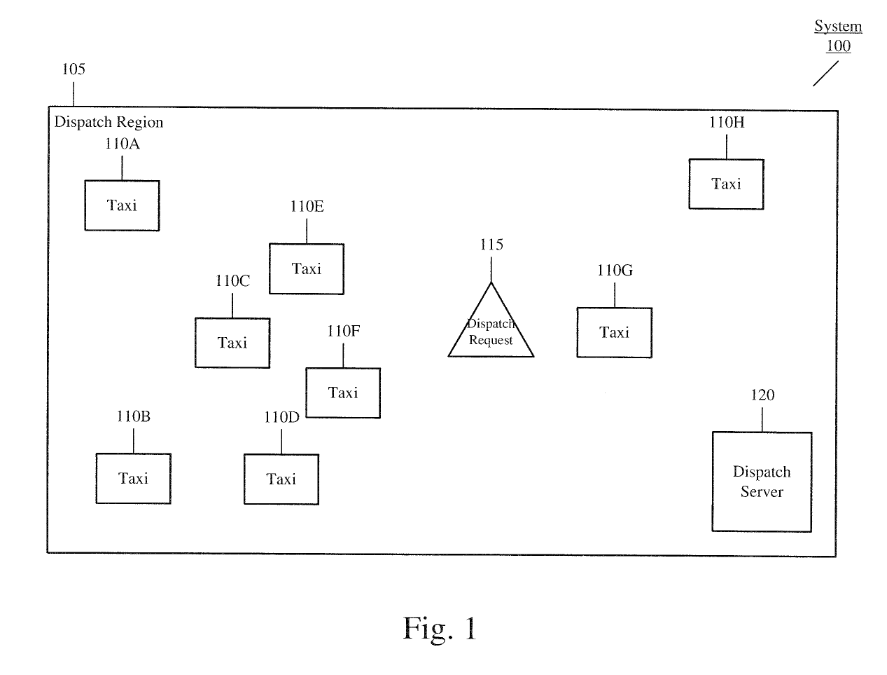

FIG. 1 shows a system of a plurality of taxis 110A-H selectable for a request according to various exemplary embodiments described herein. The system 100 illustrates a dispatch region 105 in which the taxis 110A-H may be located in any position therein. The taxis 110A-H may be used to service both unscheduled requests such as street hailed requests and scheduled requests such as dispatch requests. It may be assumed that the taxis 110A-H are all being used to service requests during a particular time duration. However, there may be one or more taxis that are in the dispatch region 105 but not currently servicing requests. Although the dispatch area 105 may be divided into a plurality of different zones, when determining which of the taxis 110A-H to select to offer a dispatch request 115, zonal constraints may be omitted from consideration. Thus, zonal constraints may remain for the taxis 110A-H at least to service street hailed requests but are ignored when attempting to service the dispatch request 115. The system 100 may also include a dispatch server 120. The dispatch server 120 may be a component of a dispatch center (not shown) that receives the dispatch request 115, determines a selected one of the taxis 110A-H that has a lowest cost in efficiently servicing the dispatch request 115, and generates an offer to the selected one of the taxis 110A-H corresponding to the dispatch request 115.

The taxis 110A-H may include various components that enable communications to be performed among each other and with the dispatch server 120 (and more generally with the dispatch center). For example, the taxis 110A-H may include dedicated short-range wireless communication components. Accordingly, voice data may be transmitted (in unicast or broadcast) to or from the dispatch server 120. It is noted that the communication component of the taxis 110A-H may use any type of communication protocol that enables any type of data to be exchanged among the components of the system 100. For example, other types of data may include an identification of the taxis 110A-H to indicate how data including the voice data may be correlated to a proper identification.

The taxis 110A-H may also include various components that determine various characteristics of the taxis 110A-H. In a first example, the taxis 110A-H may include a geolocation component to determine a location of the taxis 110A-H in the dispatch region 105 and/or relative to the other taxis 110A-H. The location of the taxis 110A-H may be transmitted to the dispatch server 120. In a second example, the taxis 110A-H may include meters that are used to track a fare in servicing a request. The meter may be engaged when the service for the request has started (e.g., upon a passenger being picked up) and disengaged when the service for the request has completed (e.g., upon a passenger being dropped off). The meter use of the taxis 110A-H may be transmitted to the dispatch server 120. It is noted that based on the location and meter use of the taxis 110A-H, the dispatch server 120 may extract other pieces of information (e.g., an average speed used in servicing the request, a status of availability of the taxis 110A-H, a zone in the dispatch region 105 that the taxis 110A-H are currently present, etc.). However, the taxis 110A-H may also be configured to determine this information and transmit corresponding data to the dispatch server 120. In a third example, the taxis 110A-H may include a clock or other timing mechanism to generate a timestamp for the associated information at the time of measurement. The clock of the taxis 110A-H may be synchronized with a clock of the dispatch server 120 using any known mechanism.

The taxis 110A-H may be configured to generate the data and transmit the data to the dispatch server 120 at different times. In a first example of generating the data, the taxis 110A-H may continuously generate the data while each of the taxis 110A-H is on a shift. That is, the data may continue to be generated while a street hailed request or a dispatch request is being serviced or the taxi is empty. In a second example of generating the data, the taxis 110A-H may intermittently generate the data at predetermined or dynamic time intervals. In a first example of transmitting the data, the taxis 110A-H may continuously transmit current location and status information. In a second example of transmitting the data, the taxis 110A-H may intermittently transmit the data at predetermined or dynamic intervals. In a particular example, the taxis 110A-H may transmit the data every minute (e.g., to retain a real-time update while reducing a processing requirement of the dispatch server 120). The generation and transmission of the data may be performed in any combination of the examples above.

It is noted that the configuration and positions of the components of the system 100 in the dispatch region 105 is only exemplary. In a first example, the number of taxis 110A-H is only exemplary. Those skilled in the art will understand that there may be any number of taxis that may be present in the dispatch region 105. In a second example, the relative positions of the taxis 110A-H in the dispatch region 105 are only exemplary. With the taxis 110A-H servicing both street hailed requests and dispatch requests, the location of the taxis 110A-H at any particular moment in time is random. In a third example, the dispatch region 105 may be any size and shape with zones therein also being of any size and shape. In a fourth example, the dispatch server 120 (and/or the dispatch center) being disposed in the dispatch region 105 is only exemplary. The dispatch server 120 may be in any location where a capability of communications with the taxis 110A-H is possible.

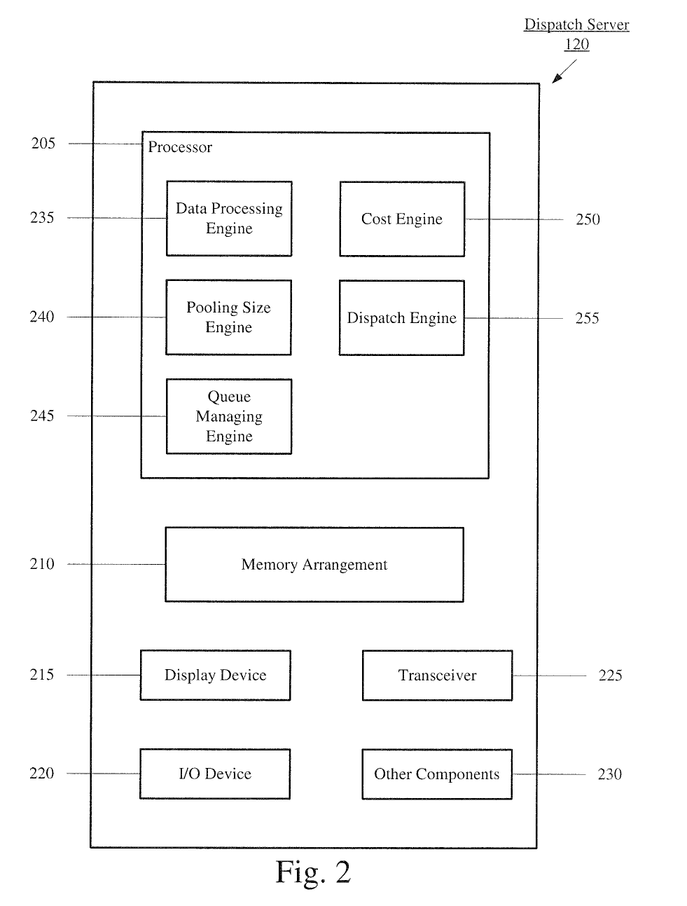

FIG. 2 shows the dispatch server 120 of the system 100 of FIG. 1 according to the exemplary embodiments. Specifically, the dispatch server 120 is configured to execute a plurality of engines that perform functionalities to receive data from the taxis 110A-H, receive the dispatch request 115, determine which dispatch scheme to use (dynamic pooling scheme or modified queuing scheme), and determine a pairing of one of the taxis 110A-H with the dispatch request 115. The dispatch server 120 may represent any electronic or networking device that is configured to perform the functionalities to be described in further detail below. The dispatch server 120 may include a processor 205, a memory arrangement 210, a display device 215, an input/output (I/O) device 220, a transceiver 225, and other components 230. The other components 230 may include, for example, an audio input device, an audio output device, a battery, a data acquisition device, ports to electrically connect the dispatch server 120 to other electronic devices, etc.

The processor 205 may be configured to execute a plurality of engines of the dispatch server 120. For example, the engines may include a data processing engine 235, a pooling size engine 240, a queue managing engine 245, a cost engine 250, and a dispatch engine 255. As will be described in further detail below, the data processing engine 235 may receive the data from the taxis 110A-H and process the data to be used by the other engines. As will be described in further detail below, the pooling size engine 240 may receive processed data from the data processing engine 235 to determine a pooling size to be used in selecting between the dynamic pooling scheme and the modified queuing scheme. The queue managing engine 245 may receive the dispatch request 115 (e.g., directly from the passenger using an automated system of the dispatch center or from other sources including operators of the dispatch center, a third party, etc.) and further dispatch requests to be included in a dispatch queue based on, for example, a time at which the dispatch request 115 is received. As dispatch requests are serviced, the queue managing engine 245 may update the dispatch queue by removing the serviced dispatch request and shifting the remaining dispatch requests in the dispatch queue to a higher position. As will be described in further detail below, the cost engine 250 may be configured to determine a cost (e.g., a pickup wait time and a total empty taxi time) associated with a pairing of the dispatch request 115 and one of the taxis 110A-H that is available to service the dispatch request 115. The dispatch engine 255 may receive results of the cost engine 250 to generate an offer to the selected one of the taxis 110A-H corresponding to the dispatch request 115 and perform subsequent operations based on whether the offer is accepted or not.

It should be noted that the above noted engines 235-255 each being an application (e.g., a program) executed by the processor 205 is only exemplary. The functionalities associated with the engines may also be represented as a separate incorporated component of the dispatch server 120 or may be a modular component coupled to the dispatch server 120, e.g., an integrated circuit with or without firmware. For example, the integrated circuit may include input circuitry to receive signals and processing circuitry to process the signals and other information. It should also be noted that particular operations and functionalities of the engines 235-255 may be performed remotely. In a first example, the dispatch server 120 may be a system of components where the engines 235-255 may be spread out among the system. In a second example, certain functionalities of the engines 235-255 such as the data processing engine 235 may be performed by a third party and received by the dispatch server 120.

The memory 210 may be a hardware component configured to store data related to operations performed by the dispatch server 120. Specifically, the data received from the taxis 110A-H may be stored at least temporarily for use by the engines 235-255 for a given time duration. The display device 215 may be a hardware component configured to show data to a user while the I/O device 220 may be a hardware component that enables the user to enter inputs. It should be noted that the display device 215 and the I/O device 220 may be separate components or integrated together such as a touchscreen. Thus, the display device 215 and the I/O device 220 may be used by an administrator of the dispatch server 120 to control operations in performing the dispatch scheme. The transceiver 225 may be a hardware component configured to exchange data with the taxis 110A-H. For example, the transceiver 225 may be configured with the short-range wireless communication protocol used by the taxis 110A-H.

As noted above, according to the exemplary embodiments, the dynamic pooling scheme uses a pooling size that is dependent on a variety of factors that are dynamically determined based on the current circumstances of the system 100 including the taxis 110A-H. In establishing how the pooling size is to be determined, the exemplary embodiments may incorporate a plurality of different temporal variables that indicate time instances and time differences that are factors in characterizing temporal aspects of the supply and demand situation associated with the dynamic pooling scheme.

Initially, a minimum dispatch window Xᵢⱼ may represent a time difference between the availability of a taxi i (Aᵢ) and the receipt of a ride request j (Rⱼ) (e.g., the dispatch request 115). Specifically, the availability of the taxi i defined with Aᵢ may be the instant that the taxi i becomes available which is a timestamp in fractional minutes relative to a first record in a dataset. The receipt of the request j defined with Rⱼ may be the instant of registering the request j which is a timestamp in fractional minutes relative to the first record in the dataset. Accordingly, the minimum dispatch window Xᵢⱼ may be represented with the following:

Xᵢⱼ=Aᵢ−Rⱼ. (Equation 1)

The time difference of the minimum dispatch window Xᵢⱼ may be positive or negative depending on when the request arrives relative to taxi availability. For example, the time difference may be negative when the pickup request arrives after the taxi availability. If the pickup request arrives before the taxi availability, the time difference may be positive. Accordingly, the taxi may wait for a dispatch request or a passenger may wait for the availability of a taxi. These two respective cases correspond to a situation where supply of taxis exceeds demand (S>D) or a reverse situation where demand exceeds supply of taxis (S<D). In either case, servicing the dispatch request is possible only after the arrival of the later entity. That is, when S>D, the dispatch request must arrive or when D>S, the taxis must become available. Therefore, an absolute time difference of the minimum dispatch window Xᵢⱼ between the events quantifies a first portion of the total empty time for taxi or one portion of the total pickup wait time for request j.

With regard to the factors or performance indicators that are to be minimized to optimize the dispatch scheme according to the exemplary embodiments, parameters such as the availability Aᵢ of a taxi i and receipt Rⱼ of a request j as well as additional parameters may be included in defining how to calculate the factors. For example, a first additional parameter may be an instant of dispatching a taxi i to request j which is defined as Dᵢⱼ. In another example, a second additional parameter may be an empty travel time for a taxi i to reach a pickup location indicated in the request j which is defined as Tᵢⱼ. Thus, a first factor may be a total empty taxi time for a taxi i which is denoted as Eᵢ. The total empty taxi time may be defined with the following:

Eᵢ=(Dᵢⱼ−Aᵢ)+Tᵢⱼ. (Equation 2)

A second factor may be a total waiting time to fulfill a request j (e.g., the dispatch request 115) which is denoted as Wⱼ. The total waiting time may be defined with the following:

Wⱼ=(Dᵢⱼ−Rⱼ)+Tᵢⱼ. (Equation 3)

By considering these two factors, Equations 2 and 3 may establish the foundation for the dispatch server 120 to determine the performance indicators to pair a taxi i to the request j. It is noted that the empty travel time Tᵢⱼ is common to both performance indicators. Therefore, subtracting Equation 2 from Equation 3 produces a minimum dispatch window time. Specifically, the minimum dispatch window Xᵢⱼ may be reformulated with the following:

Wⱼ−Eᵢ=Aᵢ−Rⱼ= (Equation 4)

It is noted that all the variables in the above Equations 1-4 are random variables given the stochastic manner of the taxis 110A-H in the system 100. The values that the variables take on for each available taxi i and request j depend on both the temporal and spatial characteristics of supply and demand for the region. Thus, the means and standard deviations express the locations and second moments, respectively, of the statistical distributions in both space and time.

Equation 4 indicates that the minimum dispatch window Xᵢⱼ is a dominant factor in the total taxi empty time or the total pickup wait time which depends on which event occurs first according to the two cases of supply versus demand noted above. That is, the minimum dispatch window Xᵢⱼ is a function of the supply and demand situation. Accordingly, the minimum dispatch window Xᵢⱼ constrains the performance of the dispatch scheme according to the exemplary embodiments. Specifically, the minimum dispatch window Xᵢⱼ is a function of the trip volume derived from historical taxi trip records where higher trip volumes equate to time differences between both the pickup request and taxi availability to be decreased and vice-versa. As will be described in detail below, the dispatch server 120 (specifically via the data processing engine 235) may receive the historical taxi trip records (e.g., in a time frame of 5 minutes prior to a current time duration). Accordingly, the dispatch server 120 (specifically via the pooling size engine 240) of the exemplary embodiments may include a capability of monitoring the minimum dispatch window Xᵢⱼ to predict future values used to determine when and how to adapt the pooling sizes. It is noted that the minimum dispatch window may be a first aspect that affects determining the pooling size and that further aspects may also be used (as will be described in detail below).

It is noted that the data processing engine 235 may receive the data from the taxis 110A-H to derive the historical taxi trip records. As noted above, the taxis 110A-H may provide various types of information by transmitting data to the dispatch server 120 such as a location, a status, and corresponding timestamps. If the dispatch server 120 is capable of handling substantially large volumes of data, the data processing engine 235 may simply process all the data being received from the taxis 110A-H for the other engines 240-255 to perform their respective functionalities. However, to decrease processing requirements, the dispatch server 120 may distill the data from the taxis 110A-H into individual trip records that are relatively useful for the other engines 240-255.

The potentially large size of the data from the taxis 110A-H (particularly when the number of taxis in the dispatch region 105 is vastly greater than shown in FIG. 1) may impede rapid data processing by the data processing engine 235 of the dispatch server 120 (especially when the dispatch server 120 or a system represented by the dispatch server 120 constitutes low-cost computers). Therefore, the data processing engine 235 may use parallel computing processes (e.g., across a plurality of processors) to derive the individual historical taxi trip records from the data received from the taxis 110A-H, geocode the positions of events in the individual records, and store the distilled records in the memory arrangement 210 for real-time access by the other engines 240-255. It is again noted that the data processing engine 235 or select operations thereof may be performed remotely or by a third party and provided to the dispatch server 120.

To efficiently process the data from the taxis 110A-H, the data processing engine 235 may use a distillation process to derive the historical taxi trip records by recording the times and positions of meter engagements which represent a pickup position/time and meter disengagements which represent a drop-off position/time. Accordingly, the distillation process obviates a requirement to geocode all geospatial coordinates, leaving only those corresponding to the pickup and drop-off positions. In this manner, the data processing engine 235 may reduce processing costs and improve/quicken data analytics to reach a more real-time and dynamic analysis feature for the dispatch server 120.

It is also noted that the data processing engine 235 may process any available data. For example, in addition to the data from the taxis 110A-H being received in some time interval (e.g., every 1 minute), the data processing engine 235 may have access to or receive bookings data which indicates various information of historical taxi trip records for completed or canceled dispatch requests. However, it is noted that the dispatch server 120 may still perform the operations described herein with the data received from the taxis 110A-H without the bookings data. Specifically, the temporal and spatial samples of pickup and drop-off events may be used as surrogates to characterize the stochastics of supply and demand in both space and time (that would otherwise be directly indicated in the bookings data). As the drop-off positions and times are representative of available taxi supply in space and time, respectively, the actual pickup positions and times represent the spatial demand in space and time, respectively.

However, without the bookings data, there may be side effects to interpreting absolute performances when using only the data from the taxis 110A-H. For example, without bookings data, the historical taxi trip records alone are a one-to-one mapping between pickup and drop-off events. Therefore, there is a tight coupling which results in equal taxi availability and pickup request queues. The tight coupling is not capable of revealing any slackness in either the supply or the demand situations. As slackness would indicate the times and positions of excessive empty taxis or excessive pickup wait times, the dispatched pairs may be reshuffled to realize any gains. In another example, without bookings data, the supply may lag the demand in general because most drop-off events tend to occur after the pickup events. The data from the taxis 110A-G may exhibit an average lag time in taxi supply that is equal to the average trip duration. Therefore, removing an average travel time offset T_{μ} from the minimum dispatch window Xᵢⱼ may remove the wait time bias. That is, an expected wait time \hat{X}ᵢⱼ may be determined with the following:

\hat{X}ᵢⱼ=Xᵢⱼ−T_{μ}. (Equation 5)

To decouple the data, the data processing engine 235 may also drop a first pickup record and a last drop-off record from the corresponding queues. This adjustment may cause the first drop-off event to correspond with the next pickup request, rather than the first pickup request that the taxi just serviced.

The data processing engine 235 may also be configured with further operations beyond the distillation process. For example, the data processing engine 235 may further clean the data received from the taxis 110A-H or from bookings data that is being used. The cleaning process may entail filtering the data to remove redundant and/or erroneous entries.

Specifically, for any of a variety of reasons, the taxis 110A-H may have provided data that indicate two separate entries for a common servicing of a request. Accordingly, the data processing engine 235 may eliminate duplicates in the data which may ultimately affect how other operations are performed (as will be described in detail below). For other reasons, the taxis 110A-H may have provided incorrect geolocation information (e.g., global positioning system (GPS) coordinates having values of zero). Entries associated with this erroneous information may be omitted. The data may additionally include entries where the timestamps associated with a pickup event and a drop-off event are substantially close to each other. That is, entries having this type of information may not correspond to servicing a request and therefore may be omitted.

Returning to the analysis of how the dynamic pooling scheme operates, with the factor for the total empty taxi time Eᵢ and the total waiting time Wⱼ, the associated costs for these factors may be defined. Initially, the optimum pooling size to be used by the dispatch server 120 may simultaneously minimize the mean and spread in empty taxi and pickup wait times for all pairings of taxi to request. Therefore, the cost reduction objective for each dispatch event is to identify pairs of taxi to request j (i, j) that minimize both the pickup wait time and the total empty taxi time. The cost associated with the total taxi empty time Eᵢ may be defined for the request j as Cᵢⱼ and the following:

Cᵢⱼ=−Uᵢ+Tᵢⱼ (Equation 6)

where Uᵢ is a dispatch wait time for the taxi i. The cost associated with the total waiting time Wⱼ may be defined for the taxi i as Pᵢⱼ and the following:

Pᵢⱼ=−Vⱼ+Tᵢⱼ (Equation 7)

where Vⱼ is a dispatch wait time for the request j.

The minimum total cost may therefore occur when a pair (i, j) yields the net minimum cost relative to all entities (e.g., taxis) present in a current cycle (e.g., a predetermined time period in which the pooling size is to be determined and used). The empty travel time component Cᵢⱼ may have a positive cost so that a cost reduction occurs when a pairing reduces the empty travel time of taxi i. Assuming a plurality of requests and a plurality of available taxis, the request having waited the longest and the taxi having waited the longest have incurred the greatest dispatch window costs. Hence, the cost factors Uᵢ and Vᵢ for the empty taxi time and pickup wait time, respectively, is negative so that dispatching the longest waiting entity (e.g., taxi or request) results in a more substantial cost reduction than dispatching a more recent arrival (e.g., taxi or request). However, a cost minimization conflict becomes evident where the same empty travel time is not capable of minimizing simultaneously both Equations 6 and 7 when Uᵢ≠Vⱼ.

To resolve this cost minimization conflict, the dynamic pooling scheme according to the exemplary embodiments may adopt a fairness approach that services dispatch requests in the order of arrival. This resolution constrains −Vⱼ to its minimum value or equivalently the largest negative value, which is the head of the dispatch queue. Whereas the modified queuing scheme provides fairness to both the taxis and the passengers (specifically the requests), the dynamic pooling scheme according to the exemplary embodiments provides fairness only to the passengers. That is, the dispatched taxi that realizes the minimum empty travel time for the head of the request in the dispatch queue may be a later arriving taxi and not the taxi waiting the longest (e.g., in an availability queue). Nevertheless, the stochastics of pooling and through a selection made with the dynamic pooling scheme reward all the taxis for a current cycle with an average reduction in empty travel time that exceeds the average wait time to dispatch on an individual level. Therefore, the gains from the empty travel time reduction outweighs the loss from additional wait time while parked. A further gain is realized from a reduction in fuel consumption. An additional benefit may be the removal of traffic which positively affects the reduction of congestion (an external factor that may significantly affect an efficiency of dispatching taxis in the dispatch region 105).

Further derivations may provide additional insights into the cost minimization conflict. By rearranging the definition for the minimum dispatch window Xᵢⱼ of Equation (1), a dispatch request pickup time may be determined with the following:

Rⱼ=Aᵢ−Xᵢⱼ (Equation 8)

Substituting Equation 8 into Equations 2 and 3 then yields the following:

Wⱼ=(Dᵢⱼ−Aᵢ+Xᵢⱼ)+Tᵢⱼ. (Equation 9)

and

Eᵢ=(Dᵢⱼ−Rⱼ−Xᵢⱼ)+Tᵢⱼ. (Equation 10)

For dispatch requests in a dispatch queue, the dispatch time Dᵢⱼ is the taxi availability time Aᵢ or the pickup time Rⱼ of the dispatch request, whichever comes later which may be expressed with the following:

Dᵢⱼ=max(Aᵢ,Rⱼ). (Equation 11)

Substituting Equation 11 into Equations 9 and 10 and taking their respective minimum yields the following single expression:

(Eᵢ,Wⱼ)ₘₐₓ=|Xᵢⱼ|+Tᵢⱼ. (Equation 12)

This expression of Equation 12 states that either the taxi or the passenger (e.g., the dispatch request) bears the maximum time cost, whichever arrived earlier. Thus, unless both entities arrived at the same instant, only one can benefit from the minimum time cost, not both simultaneously (when viewed individually).

The absolute value of the minimum dispatch window |Xᵢⱼ| may determine the absolute minimum wait time to dispatch a taxi i and may be a function of the supply and demand characteristics. Since the total supply for a cycle is controlled by a taxi company by distributing a finite fleet size among the different zones of the dispatch region 105, the dynamic pooling scheme according to the exemplary embodiments may not be capable of controlling the minimum dispatch window but may be capable of affecting the empty travel time Tᵢⱼ. Subsequently, the empty travel time Tᵢⱼ may be the only variable subject to minimization. With proper conditions corresponding to using the dynamic pooling scheme, waiting longer to increase the pool of available taxis (up to a predetermined pooling size as determined by the pooling size engine 240) may increase the odds that a pairing (i, j) reduces the empty travel time Tᵢⱼ relative to the mean travel time. However, waiting for the pool of available taxis to grow also increases the wait time cost for each entity (both the passenger of the request and the taxis already waiting in the availability queue). Waiting for additional taxis to enter the pool results in an additional dispatch time of ΔX such that Equation (12) may be expressed with the following:

(Eᵢ)ₘₐₓ=+|Xᵢⱼ|+ΔXᵢⱼ+Tᵢⱼ. (Equation 13)

A cost minimum exists where either

∀Rⱼ<Aᵢ⇒[Wⱼ]ₘᵢₙ=|Xᵢⱼ|+ΔXᵢⱼ+[Tᵢⱼ]ₘᵢₙ (Equation 14)

or

∀Aᵢ<Rⱼ⇒[Eᵢ]ₘᵢₙ=|Xᵢⱼ|+ΔXᵢⱼ+[Tᵢⱼ]ₘᵢₙ (Equation 15)

holds. The Equations 14 and 15 highlight that within any assignment cycle in which a dispatch request is serviced, it is possible to minimize only the empty travel time Tᵢⱼ.

Based on the above Equations and the results indicated from the respective formulations, the dynamic pooling scheme according to the exemplary embodiments may be utilized as a generalization of the modified queuing scheme described above. Therefore, a cycle may be defined for each time that a taxi is dispatched to service a dispatch request. Accordingly, a dispatch cycle decreases the taxi pool size by one. Assuming a condition of the pool size meeting a criteria based on a predetermined pooling size was satisfied for the aforementioned taxi to be dispatched, dispatching a subsequent taxi for a subsequent dispatch request must wait at least one more cycle to replenish the pool of available taxis before considering a new pairing of the taxi to the pending dispatch request. As each cycle adds to the wait time of all remaining entities (both passenger and taxis), the dispatch window cost components associated therewith are increased. When the taxi pool reaches the optimum size (e.g., a predetermined pooling size as determined by the pooling size engine 240), one pairing (i, j) reduces the empty travel time Tᵢⱼ for a random taxi i more than the cost for waiting in the pool of available taxis (e.g., an availability queue). However, waiting for a pool of available taxis to grow beyond one taxi may not necessarily result in pairings that reduce the mean and spread in empty taxi and pickup wait times. Therefore, as noted above, the dispatch scheme according to the exemplary embodiments may also incorporate use of the modified queuing scheme. In determining which of the schemes to use, the dispatch server 120 (via the pooling size engine 240) may use conditional tests to determine when the pool of available taxis are to be allowed to grow (and use the dynamic pooling scheme) versus immediately dispatching the heads of each queue (and use the modified queuing scheme). As will be described in detail below, a pooling size may be determined for use in either scheme. Specifically, when it is determined to use the modified queuing scheme, the pooling size may be set to 1 such that a next available taxi is immediately dispatched. However, when it is determined to use the dynamic pooling scheme, the pooling size may be dynamically adjusted by determining the value for the pooling size that yields both a minimum pickup wait time Wⱼ and a minimum empty taxi time Eᵢ. It is noted that the pooling size engine 240 may use results from the data processing engine 235 to evaluate the pool of available taxis to include taxis that will become available in the future, particularly at a target cycle (e.g., based on an average speed of an ongoing service of a request and a known drop-off location, an estimate of when the request will be completed may be ascertained). Accordingly, the pooling size engine 240 may be configured with a look-ahead capability to determine the future availability of loaded taxis (e.g., a taxi currently servicing a request) by tracking their status and position continuously.

According to an exemplary embodiment, the look-ahead capability may be performed using a mobility-index (MI), particularly a MI in space and time (MI-ST). Although the data from the taxis 110A-H may indicate when and where a pickup event occurred as well as when and where a drop-off event occurred for a taxi trip event in servicing a request and despite geolocation information being provided at time intervals during the taxi trip event, the pooling size engine 240 may not be capable of ascertaining the actual trip distance using the actual path that was traveled. Accordingly, the MI may indicate an average travel speed. The MI may be equal to an average geodesic distance divided by an average trip duration. Accordingly, for various resolutions in space and time, the MI-ST may differ among zones and days of the week, month, or year with further variations on holidays or special days in the year (relative to where in the world or which country the dispatch area 105 or zones thereof are found). The MI-ST may underestimate an actual average speed but the MI-ST provides an agnostic measure of the lack of impedance in getting from one point on the globe to another by whatever path and mode of transportation that is available. In this manner, the MI and MI-ST may be used in the look-ahead capability.

The pooling size engine 240 may be configured to re-evaluate and adjust the pooling size to be used for cycles based on a time resolution. For example, historical data related to the dispatch region 105 may indicate that traffic patterns and supply/demand factors may remain substantially similar every hour. Thus, the pooling size engine 240 may adjust the pooling size on an hourly basis. It is noted that other time resolutions may also be used to adjust the pooling size. However, the time resolution may be based on the type of the dispatch region 105. For example, each dispatch region may have contributing factors that dictate a more aggressive or more lax time resolution to be used.

As described above, the dispatching scheme of the exemplary embodiments first determines when to wait for the pool to grow (use the dynamic pooling scheme) or otherwise immediately assign an available taxi (use the modified queuing scheme). Again, the pooling size engine 240 may be configured to determine a pooling size N used in determining which scheme is to be used for a dispatch request. The pooling size engine 240 may use data received from the taxis 110A-H to determine an initial pooling size N. For example, the trip time distribution of taxi trips for the past 5-minutes (or some other time interval resolution) may be used to provide the initial guidance to set a candidate pooling size N for further evaluation. The pooling size N is set to a value where the probability that a taxi will be available to provide a trip time is lower than the travel time at peak probability pₘₐₓ. Accordingly, the initial pooling size N may be determined with the following:

\hat{N}=Round(1/pₘₐₓ). (Equation 16)

Further evaluations based on the data received from the taxis 110A-H may indicate whether the initial pooling size N is to be modified. In a first modification evaluation, the pooling size engine 240 may determine a cost reducibility factor ρ that indicates a degree to which a pool of available taxis larger than one taxi could result in further reductions of empty travel and pickup wait times (the aforementioned factors whose costs are to be minimized). The cost reducibility factor ρ for any pairing (i, j) may be defined with the following:

$${ρ}_{ij} = \frac{{T}_{ij}}{\vert {X}_{ij} \vert + Δ {X}_{ij}} . \qquad ( Equation 17 )$$

The pooling size engine 240 may determine an average cost reducibility factor ρ from the pickup request and available taxi data information corresponding to historical taxi trip events from a predetermined time frame prior to the current cycle (e.g., 5 minute duration). A value of the average cost reducibility factor ρ that is greater than unity may indicate that the current congestion travel time dominates the minimum dispatch window Xᵢⱼ. Therefore, waiting for the pool of available taxis to grow is likely to result in pairings (i, j) that reduce the overall empty taxi travel times. That is, the average cost reducibility factor ρ that is greater than unity indicates use of the dynamic pooling scheme. Conversely, the value of the average cost reducibility factor ρ that is less than unity indicates that further gains in empty taxi travel time savings are unlikely. That is, the average cost reducibility factor ρ that is less than unity indicates use of the modified queuing scheme.

When the average cost reducibility factor ρ is greater than unity, the pooling size engine 240 may evaluate cost reduction criteria that quantify a growth time of the pool of available taxis and the potential savings in empty travel time. Again, the pooling size engine 240 may use the same set of data used in determining the initial pooling size N based on data received from the taxis 110A-H in a previous time duration. The cost reduction criteria may be defined with the following:

$$\begin{matrix}Δ {\overline{X}}_{ij} = \frac{1}{\overline{{λ}_{s}}} \hat{N} < {\overline{τ}}_{ij} \\ and & ( Equation 18 ) \\ \frac{1}{\overline{{λ}_{s}}} \hat{N} << {\overline{T}}_{ij} . & ( Equation 19 )\end{matrix}$$

Therefore, the mean additional dispatch wait time may be a ratio of a size of the pool of available taxis to a mean taxi supply rate λ̅ₛ. That is, the mean time required for the pool of available taxis to grow to N taxis is N(1/λ̅ₛ). The quantity 1/λ̅, may be the mean time between available taxis. For the dynamic pooling scheme to provide an improvement to optimization, the additional dispatch wait time investment of ΔX yields a larger empty travel-time savings τ̅ᵢⱼ. Furthermore, the additional dispatch wait time investment ΔX should be substantially smaller than the expected congestion travel time τ̅ᵢⱼ. It is noted that an administrator of the dispatch server 120 may determine the value of the empty travel-time savings τ̅ᵢⱼ that would be amenable (e.g., based on business decisions). However, it is also noted that the empty travel-time savings τ̅ᵢⱼ is at least 50% larger than the additional dispatch wait time investment of ΔX. The administrator of the dispatch server 120 may also determine the amount of additional wait time investment for dispatching that is suitable. It is noted that according to one exemplary embodiment, the additional wait time investment may be a factor of two to four smaller than the expected travel time.

When the dynamic pooling scheme is to be used and the initial pooling size N is evaluated, the pooling size engine 240 may modify the pooling size N by iteratively decrementing the estimate of N until the value satisfies the cost reduction criteria as defined in Equations 18 and 19. It is noted that the pooling size engine 240 may also increment the estimate of N while the conditions are still satisfied. For example, there may be a scenario where the initial estimate of the pooling size N is too low such that the pooling size engine 240 may attempt to increment the pooling size N and determine if the cost reduction criteria of Equations 18 and 19 are still satisfied. It is noted that prior test and simulations have been performed and have revealed that there are diminishing returns for an average size of the pool of available taxis to be greater than six. Accordingly, the exemplary embodiments are configured to start with an initial estimate of the pooling size N based on a maximum likelihood travel time and decrement the estimate of the pooling size N until the conditions of the Equations 18 and 19 are satisfied or the value reaches unity (at which point the pooling size engine 240 instead sets the pooling size to 1).

The travel time associated with the peak probability pₘₐₓ may also be noted. Specifically, the travel time may correspond to the empty travel time Tᵢⱼ. In a particular example, the data from the taxis 110A-H may indicate a peak probability ρₘₐₓ is 5.5% for a maximum likelihood travel time Tᵢⱼ of 17 minutes. Thus, according to Equation 16, the pooling size may be determined to be N=18 (e.g., 1/5.5% rounded to the lowest or nearest whole number). Using Equation 19 where N=18 and Tᵢⱼ=17, the taxi supply rate is determined to be λ̅ₛ>>1.1 per minute. Accordingly, to meet this criteria, the taxi supply rate must be greater than 1.1 per minute. The degree upon which this criteria may be met may be based on various statistical analyses such as a number of standard deviations from this value. It is noted that the above values are only exemplary and were used to provide a concrete example of a solution to the problem.

It is noted that the pooling size engine 240 may include another mechanism to determine the pooling size to be used in the dynamic pooling scheme. For example, the pooling size engine 240 may estimate the pooling size using a modeling mechanism. Specifically, the pooling size engine 240 may utilize a parallel simulation of historical taxi trip events to train a model and produce the optimum pooling size based on a variety of parameters. The model may be parametric (e.g., regression) or non-parametric (e.g., Bayesian or an artificial neural network). According to a particular exemplary embodiment, the model may be trained using a simple parametric model based on trip volume within some resolution of time (e.g., one hour). The model may be more complex to include other factors such as spatial characteristics. For example, the model may include both temporal and spatial factors. In particular, the model may include both the trip volume as well as parameters of the trip length distribution for the past hour. In this manner, the pooling size may be determined using the modeling mechanism to determine the initial pooling size which may then be evaluated with the cost reducibility factor (e.g., Equation 17) and cost reduction criteria (e.g., Equations 18 and 19).

As noted above, the TNCs utilize algorithms that do not include zonal constraints. The dynamic pooling scheme for servicing dispatch requests may also omit zonal constraints. The above described conditional tests provide evidence that the relatively low supply rates of individual zones cap the potential for large efficiency gains in dispatching. By extension, removing zonal constraints increase the overall supply rate across the entire dispatch region 105. Accordingly, this improves the probability of satisfying the cost reduction criteria of Equations 18 and 19. The probability is further improved with the degree of overlap in supply and demand hotspots which may cross boundaries of zones.

Once the pooling size has been determined, the engines 235-255 of the dispatch server 120 may perform further operations to determine the optimal pairing (i, j) that maximally reduces the costs Cᵢⱼ and Pᵢⱼ. As the data processing engine 235 continuously processes the data being received from the taxis 110A-H and the pooling size engine 240 determines the pooling size N to be used, the queue managing engine 245 may also be receiving dispatch requests (e.g., the dispatch request 115) and maintaining the dispatch queue. The queue managing engine 245 may also receive the processed data from the data processing engine 240 to determine available ones of the taxis 110A-H and maintain an availability queue.

As noted above, the dispatch server 120 (via the pooling size engine 240) may attempt to service dispatch requests based on cycles or after a top priority dispatch request in the dispatch queue has been serviced (e.g., assuming a temporal order from oldest to newest, the top priority dispatch request is the oldest one in the dispatch queue). When the top priority dispatch request has been serviced, an entry each queue is removed (e.g., the selected taxi who accepted the dispatch request is removed from the availability queue and the top priority dispatch request is removed from the dispatch queue). Thus, to proceed with servicing a subsequent dispatch request in the dispatch queue, an event is monitored to occur prior to proceeding. Assuming the pool of available taxis had satisfied the condition set with the predetermined pooling size, removal of a taxi from the availability queue may include an implication that the condition is no longer met. Accordingly, the event may be when a new taxi is introduced or added into the availability queue (e.g., a taxi has completed or is expected to complete a dispatch or street hailed request). The addition of a new available taxi may be a trigger for the subsequent operations of the dispatch server 120 to be performed.

With the addition of a new available taxi, the pooling size engine 240 may compare the predetermined pooling size N to the pool of available taxis (e.g., a number of available taxis in the availability queue). Specifically, the comparison may be whether the pool of available taxis has a number that is less than the predetermined pooling size N. As discussed above, if the pooling size engine 240 determines that the modified queuing scheme is to be used, the pooling size N may be set to 1. Accordingly, the pool of available taxis is compared to the predetermined pooling size N of 1. Those skilled in the art will understand that the predetermined pooling size N being set to 1 results in any positive number in the pool of available taxis to satisfy this condition of not being less than the pooling size N. Accordingly, the dispatch server 120 may not wait and proceed with determining which of the available taxis to pair with the dispatch request 115 for service. It is noted that if there is only one available taxi in the pool, the dispatch server 120 may immediately select this one taxi for matching under the modified queuing scheme. Since the event of a new available taxi triggers this operation, it may be assumed that there is always at least one available taxi in the availability queue.

When the predetermined pooling size N is a value greater than 1 and the dynamic pooling scheme is to be used, the available taxis in the pool may not satisfy the condition based on the predetermined pooling size N. When the pool of available taxis is less than the predetermined pooling size N, the dispatch server 120 may wait until another new taxi enters the pool of available taxis. This process may repeat until the pool of available taxis is at least the predetermined pooling size N. As noted above, the dynamic pooling scheme uses an additional wait time for the available taxis in the pool but ultimately leads to an average decrease to this associated cost to optimize the dispatch scheme overall. Once the pool of available taxis is at least the predetermined pooling size N, the dispatch server 120 may continue with subsequent operations to match one of the available taxis to the dispatch request 115.

Regardless of how the subsequent operations are reached via the modified queuing scheme approach or the dynamic pooling scheme approach, the dispatch server 120 via the cost engine 250 may perform a cost analysis. Specifically, each entry in the pool of available taxis (as indicated in the availability queue) is used to determine an associated cost of servicing the dispatch request 115 that is being processed. As described above, the cost engine 250 may determine the costs Cᵢⱼ and Pᵢⱼ using Equations 6 and 7, respectively, such that a pairing (i, j) having a minimum cost is determined (e.g., where ∥Pᵢⱼ+Cᵢⱼ∥ₘᵢₙ is found). It is again noted that the dynamic pooling scheme provides fairness only to passengers and with removal of zonal constraints, any of the available taxis in the pool may be considered in the cost analysis to determine the optimal pairing, even a most recently added taxi to the pool including the taxi that triggered the subsequent operations.

Once the optimal pairing having the lowest associated cost has been determined, the dispatch engine 255 may receive the results from the cost engine 250. The dispatch engine 255 may generate an offer to the identified taxi. As the taxis may still refuse to accept the dispatch request, the dispatch engine 255 may receive a response prior to processing and completing the dispatch request (e.g., remove from the dispatch queue). If the identified taxi refuses the offer corresponding to the dispatch request, the pooling size engine 240 may initially do another comparison of the pool of available taxis to the predetermined pooling size N. If the condition is not met, the pooling size engine 240 may wait until at least one new available taxi is added to the pool. Subsequently, another cost analysis is performed by the cost engine 250. This process may continue or repeat until one of the available taxis in the pool accepts the offer for the dispatch request 115. Thereafter, the dispatch engine 255 may generate a signal or result of the successful pairing to the queue managing engine 245. The queue managing engine 245 may remove the dispatch request 115 from the dispatch queue and continue onto the next dispatch request in the dispatch queue.

The dispatch scheme used by the exemplary embodiments in which a modified queuing scheme is used under a first set of conditions in the system 100 and a dynamic pooling scheme is used under a second set of conditions in the system 100 affords a dynamically selectable mechanism to dispatch taxis in servicing dispatch requests while still maintaining the capability of also servicing street hailed requests. Due to the randomness and dispersion of taxi supply across both space and time, the dynamic dispatch scheme may provide further optimizations in taxi dispatch. The dispatch scheme according to the exemplary embodiments may anticipate likely reductions in empty taxi travel time by waiting for a spatially diverse pool of available taxis to grow before determining an optimal pairing and dispatching the taxi to service the dispatch request. Using different criteria to guide initial operations performed by the dispatch server 120 in determining a pooling size, an initial pooling size may be tested against several cost reducibility considerations (the initial pooling size being determined as a function of trip time distribution or determined using a data-driven model). Through adjustments to the pooling size until a cost reducibility factor condition is met and several cost reduction criteria are met, the pooling size to be used for subsequent operations may vary dynamically from a single taxi (which indicates using the modified queuing scheme) to many taxis when the trip demand volume is sufficiently large (which indicates using the dynamic pooling scheme). The cost reduction conditions may ensure that the estimated time taken to grow the pool of available taxis likely yield much larger savings in congestion travel time in an overall effect to all entities in the system 100 (including both drivers of taxis and passengers of dispatch requests, where the drivers may be humans or artificial intelligence such as robots, computers with sensors, etc.).

Although zonal constraints may be retained as an overall condition to the taxis 110A-H in the dispatch zone 105, when considering selecting one of the taxis 110A-H to service a dispatch request, the zonal constraints may be removed or omitted as these zonal constraints serve as a performance cap. Specifically, zonal constraints may cap a rate of taxi availability within that zone. Furthermore, zonal constraints may force taxis to return empty to a designated zone before any consideration to service a dispatch request which results in a time bias or an offset in the average time that taxis actually become available near a pickup location, within a designated zone. The removal of these zonal constraints releases the caps on taxi supply rates to provide substantial efficiency gains. By removing the zonal constraints, there is a high confidence that a rate increase across the entire dispatch region 105 improves the probability of pairing dispatch requests that are within close proximity of a recent drop-off position of an available taxi.

With the taxi supply rate accounting for a significant portion (e.g., more than 90%) of the accuracy in estimating a parametric model to guide the optimum selection of a pooling size, larger pool sizes intuitively enhance the odds of finding a pairing that reduces the dominant cost factor such as the empty taxi travel time. The next consideration in using the pooling size may be to determine the duration of time needed for the pool of available taxis to grow relative to the savings in congestion travel time achieved. A high rate of supply minimizes the amount of time that the pool takes to grow to the pooling size. For example, simulations and tests have indicated that the pooling size of six taxis may be used as a benchmark or a point of diminishing returns in relatively low trip volume scenarios.

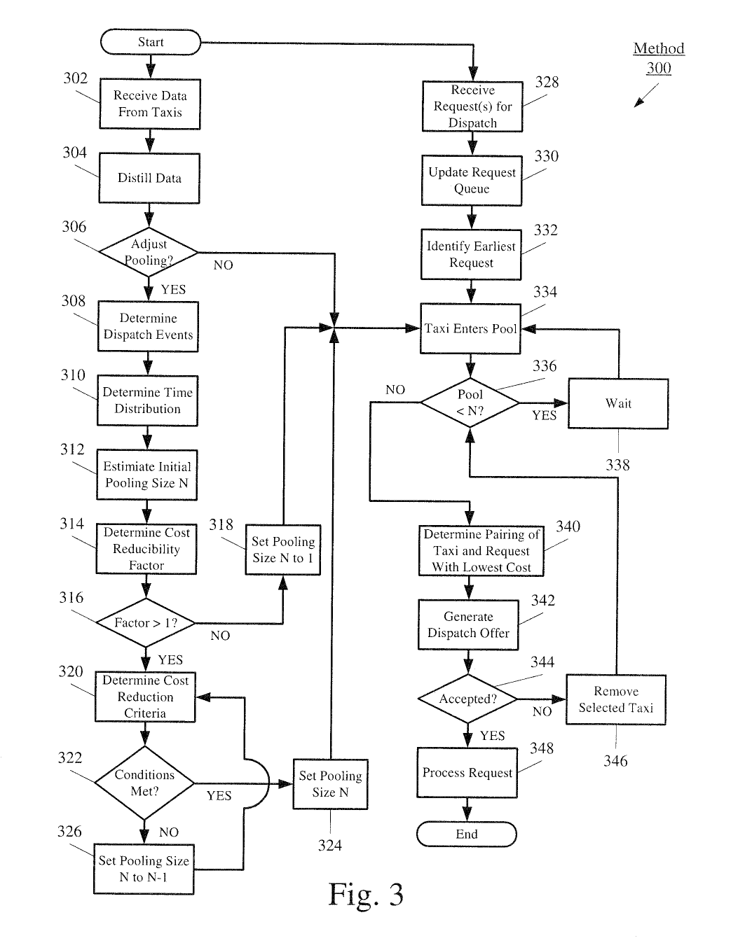

FIG. 3 shows a method 300 for determining how a taxi is selected to service a request according to various exemplary embodiments described herein. The method 300 may relate to how the dispatch server 120 dynamically determines whether the dispatch scheme according to the exemplary embodiments is to use the modified queuing scheme or the dynamic pooling scheme by determining a pooling size and subsequently pairing a taxi to a dispatch request that has a lowest associated cost. The method 300 will be described from the perspective of the dispatch server 120. Thus, the method 300 is performed by the dispatch server 120 and the method 300 will be described with regard to the system 100 of FIG. 1.

In 302, the dispatch server 120 receives data from the taxis 110A-H. As described above, the taxis 110A-H may be configured with the proper hardware, software, and/or firmware to generate data corresponding to various characteristics or parameters as well as the proper hardware, software, and/or firmware (e.g., short-range or long-range communications protocols) to transmit this data to the dispatch server 120 (being received by the dispatch server 120 via the transceiver 225). This data may be transmitted to the dispatch server 120 at intermitted time intervals (e.g., every minute). Accordingly, the data from the taxis 110A-H may indicate an identity of the taxi, meter engagements/disengagements, geolocation information, etc. along with corresponding timestamps. In 304, the dispatch server 120 distills and/or cleans the data. Specifically, the dispatch server via the data processing engine 235 may distill the data to generate historical taxi trip records. The historical taxi trip records may also be generated based on a predetermined duration of time from a present time (e.g., 5 minutes in the past).

In 306, the dispatch server 120 determines whether a pooling size is to be adjusted. As described above, the dispatch server 120 may determine a pooling size that is to be used in subsequent operations. The pooling size may be modified by adjusting to match real-time conditions. Accordingly, the dispatch server 120 may track how long a pooling size has been used and upon expiry of an associated timer, the dispatch server 120 may re-evaluate the pooling size. If the pooling size does not require adjustment, the dispatch server 120 continues the method 300 to 334 (to be described in detail below). However, if the pooling size is to be adjusted, the dispatch server 120 continues the method 300 to 308.

In 308, the dispatch server 120 determines the dispatch events as derived from the data received from the taxis 110A-H. Specifically, the processed data from the data processing engine 235 may be used by the pooling size engine 240 to determine the historical taxi trip events. Based on the historical taxi trip events (e.g., from the past 5 minutes), in 310, the dispatch server 120 may determine a time distribution (e.g., a travel time at peak probability) or use a modeling approach via a parametric or non-parametric model. Based on this information, in 312, the dispatch server 120 may estimate an initial pooling size to be further evaluated. For example, Equation 16 may be used in determining the initial pooling size based on the probability value corresponding to the peak travel time.

In 314, the dispatch server 120 may determine a cost reducibility factor. Specifically, the pooling size engine 240 may determine the cost reducibility factor based on an empty travel time, an absolute value of a minimum dispatch window, and a difference in minimum dispatch windows. In 316, the dispatch server 120 may determine whether the cost reducibility factor is greater than unity. When the cost reducibility factor is greater than unity, waiting for a pool of available taxis to grow or using the dynamic pooling scheme may provide improved performance. When the cost reducibility factor is at most unity, there may be no further gains in empty taxi travel time savings. That is, using the modified queuing scheme may provide improved performance over using the dynamic pooling scheme when the cost reducibility factor is at most unity. If the cost reducibility factor is at most unity, the dispatch server 120 continues to 318 where the pooling size is modified from the initial pooling size. Specifically, the pooling size is set to 1. Thereafter, the dispatch server 120 continues to 334. However, if the cost reducibility factor is more than unity, the dispatch server 120 continues to 320.

In 320, the dispatch server 120 may determine how the pooling size may be changed based on further considerations. Specifically, the pooling size engine 240 may determine cost reduction criteria based on the historical taxi trip events (e.g., for the past 5 minute time duration). Whether the cost reduction criteria are satisfied may be determined using Equations 18 and 19 in which a taxi supply rate is used as a basis given the gravity of its effect in evaluating the criteria. In 322, the dispatch server 120 determines whether the conditions of the cost reduction criteria have been met. If the conditions have been met, the dispatch server 120 continues to 324 where the pooling size is kept at the initial pooling size. However, if the conditions are not met, the dispatch server 120 continues to 326 where the initial pooling size is reduced by 1 to a new pooling size to be evaluated. The dispatch server 120 may repeat 320, 322, and 326 until the conditions of the cost reducibility factor have been met. Once the conditions are met, the most recently reduced value of the pooling size is used to set the pooling size for use in subsequent operations. After 324, the dispatch server 120 continues to 334.

As a parallel operation, the dispatch server 120 may also perform further operations associated with the dispatch requests. Specifically, in 328, the dispatch server 120 may receive a dispatch request (e.g., dispatch request 115). As described above, the queue managing engine 245 may receive one or more dispatch requests from a variety of sources, the queue managing engine 245 maintaining a dispatch queue including the dispatch requests in the order of arrival, the earliest received dispatch request remaining in the dispatch queue having a highest priority. Thus, when the dispatch server 120 receives a dispatch request, in 330, the queue managing engine 245 updates the dispatch queue. In 332, the dispatch server 120 determines the earliest dispatch request in the dispatch queue having the highest priority. This dispatch request may be processed for service.

With the dispatch server 120 performing 302-324 and 328-332 in parallel, the operations may merge when a new cycle has occurred. As noted above, the new cycle may be when a pairing of a taxi to a dispatch request has been determined and dispatched for service. Thus, the next priority dispatch request in the dispatch queue may be processed in a new cycle. With the new cycle being triggered from removal of a taxi in the availability queue and removal of the dispatch request in the dispatch queue, and with an assumption of having to replace the removed taxi in the pool of available taxis, an event that triggers the subsequent operations in processing the next dispatch request is the arrival or addition of a new available taxi to the pool.

In 334, a new taxi enters the pool of available taxis. When this event has occurred, in 336, the dispatch server 120 determines whether the pool of available taxis is less than the predetermined pooling size that was set with the pooling size engine 240. As described above, when the modified queuing scheme is to be used and the predetermined pooling size is set to 1, the pool of available taxis is never less than the predetermined pooling size as there is at least one taxi in the pool of available taxis. Accordingly, the dispatch server 120 may continue directly to 340. However, when the dynamic pooling scheme is to be used and the predetermined pooling size is greater than 1, the pool of available taxis may be less than the predetermined pooling size. As the conditions warrant using the dynamic pooling scheme, there may be gains from waiting until the pool of available taxis reaches the predetermined pooling size. Thus, if the pool of available taxis is less than the predetermined pooling size, the dispatch server 120 continues to 338 where the dispatch server 120 waits until a new taxi is added to the pool of available taxis (in 334). This operation may continue until the pool of available taxis is at least the predetermined pooling size. For example, a taxi in the availability queue may have accepted a street hailed request and is now removed from the pool of available taxis. Thus, more than one taxi may be required to be added to the pool of available taxis prior to continuing. Once the condition of the pool of available taxis being at least the predetermined pooling size is met (from either the predetermined pooling size being set to 1 from using the modified queuing scheme or being set to greater than 1 from using the dynamic pooling scheme), the dispatch server 120 continues to 340.

In 340, the dispatch server 120 determines a respective cost associated by pairing each of the taxis from the pool of available taxis with the dispatch request being processed. Specifically, the cost engine 250 may use Equations 6 and 7 to determine the corresponding costs of a total empty time for a selected taxi to a total waiting time to fulfill the dispatch request (e.g., to at least perform a pickup). Based on the costs that are determined, the dispatch server 120 may select the pairing of taxi to dispatch request that has a lowest associated total cost.

In 342, the dispatch server 120 may generate a dispatch offer for the selected taxi in the pairing with the lowest associated total cost. Specifically, the dispatch engine 255 may generate the offer and transmit the offer to the selected taxi. Assuming that the offer is not mandatory, the dispatch engine 255 may receive a response to the offer. In 344, the dispatch engine 120 may determine if the offer was accepted or rejected. If the offer was rejected, in 346, the dispatch engine 255 may remove the selected taxi from further consideration. It is noted that the taxi may not necessarily be removed from an availability queue but is removed from further consideration in servicing the current dispatch request being processed. The dispatch server 120 may return to 336 to ensure that the pool of available taxis still satisfies the condition of being at least the predetermined pooling size. This process may continue until a selected taxi having the lowest associated total cost in servicing the dispatch request accepts the offer. Thus, in 348, the dispatch server 120 processes the dispatch request. For example, the dispatch request may be removed from the dispatch queue and the selected taxi may be removed from the availability queue. Thereafter, the dispatch server 120 may return to 302 and 328 to continue to perform the method 300 in an iterative manner to process all remaining and newly incoming dispatch requests in the dispatch queue.

The exemplary embodiments provide a device, system, and method of optimizing a dispatch scheme. The dispatch scheme may operate in a dynamic manner where a first set of conditions indicates use of a modified queuing scheme while a second set of conditions indicates use of a dynamic pooling scheme. The dynamic pooling scheme may enable increased gains by waiting for a pool of available taxis to grow until a predetermined pooling size has been reached. Although at an individual level, the empty taxi times may be increased, the dynamic pooling scheme decreases an overall cost associated with empty travel times for all entities in the system (both passenger and driver). Accordingly, the most efficient manner of deploying taxis to service a dispatch request is dynamically selected for maximum optimization.

By further implementing the dynamic pooling scheme into a centralized dispatching platform that services dispatch requests, the exemplary embodiments use data received from the taxis in the system to continuously track a respective status and position for each taxi in a near real-time manner. The exemplary embodiments may also estimate a congestion travel time to provide the estimate as a real-time input for various operations requiring this information. The substantial reduction in the mean and spread of empty taxi times realized using the dispatch scheme according to the exemplary embodiments demonstrate that more efficiency may be realized from removing zonal constraints. The reduction in mean and spread of the pickup wait times realized demonstrates that the level of service will improve substantially without needing to increase the fleet size or the number of drivers/vehicles. Even with increase service improvement which may lead to an increase in demand over time, the exemplary embodiments may compensate for changes in supply and/or demand by modifying the approach being used via selection of the modified queuing scheme or the dynamic pooling scheme and setting of a dynamic pooling size.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
in a system comprising a plurality of delivery vehicles to perform deliveries located within a dispatch region and a dispatch center processing dispatch requests for delivery from a pickup location to a drop-off location, the delivery vehicles configured to transmit data to the dispatch center, the data including status information with corresponding timestamps indicative of an availability of the delivery vehicles:
receiving a new dispatch request, the new dispatch request including a new pickup location and a new drop-off location;
determining whether one of the delivery vehicles is to be selected based on a dynamic pooling scheme, the dynamic pooling scheme waiting for the pool of the at least one available delivery vehicles to grow to reach a predetermined pooling size prior to selecting one of the delivery vehicles to pair with the new dispatch request;
determining a respective overall cost associated with each pairing of the at least one available delivery vehicle to the new dispatch request;
selecting a pairing based on the respective overall costs; and
dispatching the selected available delivery vehicle in the optimal pairing to service the new dispatch request.

2. The method of claim 1, wherein the overall cost is further based on a location of the available delivery vehicle and the new pickup location of the new dispatch request.

3. The method of claim 1, wherein the data further includes location information with corresponding further timestamps for respective delivery vehicles indicative of a position within the dispatch region.

4. The method of claim 1, further comprising:
determining when one of the delivery vehicles that was unavailable becomes available.

5. The method of claim 4, further comprising:
determining whether one of the delivery vehicles is to be selected based on a modified queuing scheme selecting the one of the delivery vehicles to pair with the new dispatch request from a pool of at least one available one of the delivery vehicles.

6. The method of claim 5, wherein, with the modified queuing scheme, the predetermined pooling size is set to 1.

7. The method of claim 6, wherein, with the dynamic pooling scheme, the predetermined pooling size is set to a value greater than 1.

9. The method of claim 7, further comprising:
determining a cost reducibility factor for each pairing of the at least one available delivery vehicle to the new dispatch request, the cost reducibility factor being based on an empty travel time and a minimum dispatch window;
when the cost reducibility factor is at most unity, selecting the modified queuing scheme; and
when the cost reducibility factor is more than unity, selecting the dynamic pooling scheme.

9. The method of claim 1, further comprising:
(a) estimating an initial pooling size derived from the data received from the delivery vehicles within a predetermined prior time duration;
(b) when the dynamic pooling scheme is selected, determining whether the initial pooling size is to be adjusted based on cost reduction criteria, the cost reduction criteria being based on a vehicle supply rate in which the delivery vehicles change a status from unavailable to available;
(c) when the cost reduction criteria are not met, reducing the initial pooling size by 1;
(d) repeating (b) and (c) until the cost reduction criteria are met; and
(e) when the cost reduction criteria are met, setting the predetermined pooling size as one of the initial pooling size or the reduced pooling size.

10. The method of claim 9, wherein the estimating the initial pooling size is based on one of a time distribution including a travel time at a peak probability or one of a parametric or a non-parametric model.

11. The method of claim 1, wherein the overall cost of a pairing of a selected one of the at least one available delivery vehicle to the new dispatch request is based on a total time the selected available delivery vehicle is not performing deliveries and a total waiting time to start the new dispatch request by the selected available delivery vehicle.

12. The method of claim 1, wherein the delivery vehicles are taxis.

13. The method of claim 12, wherein the dispatch requests are scheduled requests and the taxis are further used for unscheduled requests.

14. A dispatch server processing dispatch requests for delivery from a pickup location to a drop-off location in a dispatch region, the dispatch region including a plurality of delivery vehicles to perform deliveries, the dispatch server comprising:
a transceiver configured to exchange data with the delivery vehicles, the data including status information with corresponding timestamps indicative of an availability of the delivery vehicles, the transceiver receiving a new dispatch request, the new dispatch request including a new pickup location and a new drop-off location; and
a processor determining whether one of the delivery vehicles is to be selected based on a dynamic pooling scheme, the dynamic pooling scheme waiting for the pool of the at least one available delivery vehicles to grow to reach a predetermined pooling size prior to selecting one of the delivery vehicles to pair with the new dispatch request, the processor determining a respective overall cost associated with each pairing of the at least one available delivery vehicle to the new dispatch request, the processor selecting a pairing based on the respective overall costs,
wherein the transceiver transmits an offer to the selected available delivery vehicle in the optimal pairing to service the new dispatch request.

14. The dispatch server of claim 13, wherein the dispatch server is a component of a dispatch center for a fleet of taxis, the delivery vehicles being the taxis.

15. The dispatch server of claim 11, wherein the data further includes location information with corresponding further timestamps for respective delivery vehicles indicative of a position within the dispatch region.

16. The dispatch server of claim 15, wherein the processor determines the overall cost based further on a location of the available delivery vehicle and the new pickup location of the new dispatch request.

17. The dispatch server of claim 13, wherein the processor determines whether the one of the delivery vehicles is to be selected based on a modified queuing scheme, the modified queuing scheme selecting one of the delivery vehicles to pair with the new dispatch request from a pool of at least one available one of the delivery vehicles, and wherein, with the modified queueing scheme, the predetermined pooling size is set to 1.

18. The dispatch server of claim 13, wherein, with the dynamic pooling scheme, the predetermined pooling size is set to a value greater than 1.

19. The dispatch server of claim 13, wherein the processor further performs operations comprising:
(a) estimating an initial pooling size derived from the data received from the delivery vehicles within a predetermined prior time duration;
(b) when the dynamic pooling scheme is selected, determining whether the initial pooling size is to be adjusted based on cost reduction criteria, the cost reduction criteria being based on vehicle supply rate in which the delivery vehicles change a status from unavailable to available;
(c) when the cost reduction criteria are not met, reducing the initial pooling size by 1;
(d) repeating (b) and (c) until the cost reduction criteria are met; and
(e) when the cost reduction criteria are met, setting the predetermined pooling size as one of the initial pooling size or the reduced pooling size.

20. A system, comprising:
a plurality of delivery vehicles located in a dispatch region, the delivery vehicles perform deliveries in the dispatch region, the delivery vehicles comprising components configured to generate and transmit data, the data including status information with corresponding timestamps indicative of an availability of the delivery vehicles and location information with corresponding further timestamps indicative of a respective position of the delivery vehicles within the dispatch region; and
a dispatch center configured to exchange the data and further data with the delivery vehicles, the dispatch center receiving a new dispatch request including a new pickup location and a new drop-off location, the dispatch center determining whether one of the delivery vehicles is to be selected based on a dynamic pooling scheme, the dynamic pooling scheme waiting for the pool of the at least one available delivery vehicles to grow to reach a predetermined pooling size prior to selecting one of the delivery vehicles to pair with the new dispatch request, the dispatch center determining a respective overall cost associated with each pairing of the at least one available delivery vehicle to the new dispatch request, the dispatch center selecting a pairing based on the respective overall costs, the dispatch center transmitting an offer to the selected available delivery vehicle in the optimal pairing to service the new dispatch request.
